(19) United States
(12) Patent Application Publication
(10) Pub. No.: US 2018/0015540 A1
(43) Pub. Date: Jan. 18, 2018

(54) METAL POWDER BONDED BODY MANUFACTURED BY ADDITIVE MANUFACTURING AND HAVING EXCELLENT HYDROGEN EMBRITTLEMENT RESISTANCE

(71) Applicant: KOREA RESEARCH INSTITUTE OF STANDARDS AND SCIENCE, Daejeon (KR)

(72) Inventors: Seung Wook BAEK, Sejong-si (KR); Seung Hoon NAHM, Daejeon (KR); Un Bong BAEK, Daejeon (KR)

(21) Appl. No.: 15/652,884

(22) Filed: Jul. 18, 2017

(30) Foreign Application Priority Data
Jul. 18, 2016 (KR) 10-2016-0090835
Jul. 10, 2017 (KR) 10-2017-0087050

(51) Int. Cl. B22F 3/00; B22F 3/10

(52) U.S. Cl. CPC B22F 3/008; B22F 3/10; B33Y 80/00; B22F 2301/35

(57) ABSTRACT

Provided is a metal powder bonded body having excellent hydrogen embrittlement resistance, wherein the metal powder bonded body is a metallic material having excellent hydrogen embrittlement resistance, the metallic material is a metal powder bonded body manufactured by incrementally adding metal powder layer by layer, and the metal powder bonded body has characteristics of ductile fracture in an area of 80% or more of a total area of a fracture section when fractured in a hydrogen atmosphere.

### CROSS-REFERENCE TO RELATED APPLICATIONS

This application claims priority to and the benefit of Korean Patent Application No. 10-2016-0090835 filed in the Korean Intellectual Property Office on Jul. 18, 2016, and Korean Patent Application No. 10-2017-0087050 filed in the Korean Intellectual Property Office on Jul. 10, 2017, the entire contents of which are incorporated herein by reference.

### BACKGROUND

The present disclosure relates to a metallic material having excellent resistance to hydrogen embrittlement which occurs when the metallic material is exposed to a hydrogen atmosphere, and more particularly, to a metallic material having excellent hydrogen embrittlement resistance which is manufactured by 3D printing.

Recently, hydrogen has emerged as a future energy medium which will ultimately replace fossil fuels. The fossil fuels emit various air pollutants during a process in which the fossil fuels are used as an energy source, and, particularly, the emission of a material, such as carbon dioxide, may cause global warming. In contrast, hydrogen is an eco-friendly energy source that does not emit a pollutant or carbon dioxide, wherein, recently, research into hydrogen cars or fuel cells using the hydrogen as an energy source has been actively conducted. In order to develop safe hydrogen economy and hydrogen society through the introduction of hydrogen electric vehicles and the introduction and spread of hydrogen energy, development of a hydrogen storage container having resistance to hydrogen corrosion, in which hydrogen may be safely stored, a pipe, and related parts is essential.

A material, from which the hydrogen storage container, the pipe, and the related parts for hydrogen service may be manufactured, must basically have excellent hydrogen embrittlement resistance. The expression “hydrogen embrittlement” in the field of metallic materials denotes a phenomenon in which a metallic material is easily broken by an external force while external hydrogen in an atomic state (H) penetrates into a metal crystal lattice to cause brittleness of the metallic material. The hydrogen embrittlement frequently occurs particularly in high-strength steel. Since the hydrogen in an atomic state has the smallest atomic diameter, the hydrogen in an atomic state may easily penetrate into metal. When tensile stress above a predetermined threshold is applied to a metallic material embrittled by hydrogen, hydrogen cracks occur, and these hydrogen cracks grow and propagate at a high speed to eventually cause brittle fracture of the metallic material. In the brittle fracture process, hydrogen moves to a crack growth tip, and it is known that fracture occurs in such a manner that, when a hydrogen concentration reaches a predetermined threshold, cracks grow while new cracks are formed in a hydrogen-embrittled region. A fracture section caused by the hydrogen embrittlement exhibits characteristics of brittle fracture in which a cleavage fracture surface typically appears. The metallic material used in the manufacture of the hydrogen storage container, the pipe, and the related parts particularly must have excellent resistance to hydrogen embrittlement in term of the fact the metallic material is subjected to an environment in contact with hydrogen for a long period of time.

### SUMMARY

The present disclosure provides a metal powder bonded body manufactured by additive manufacturing and having hydrogen embrittlement resistance that is dramatically improved in comparison to a conventional metallic material. However, the problems are exemplary, and the scope of the present disclosure is not limited by the problems.

In accordance with an embodiment, there is provided a metal powder bonded body having excellent hydrogen embrittlement resistance, wherein the metal powder bonded body is a metallic material having excellent hydrogen embrittlement resistance, the metallic material is a metal powder bonded body manufactured by incrementally adding metal powder layer by layer, and the metal powder bonded body has characteristics of ductile fracture in an area of 80% or more of a total area of a fracture section when fractured in a hydrogen atmosphere.

In the characteristics of ductile fracture in the area of 80% or more of the total area of the fracture section, a fracture mode including dimples without a cleavage plane may be shown in the area of 80% or more of the total fracture section during observation of the fracture section.

In accordance with another embodiment, there is provided a metal powder bonded body having excellent hydrogen embrittlement resistance, wherein the metal powder bonded body is a metallic material having excellent hydrogen embrittlement resistance, the metallic material is a metal powder bonded body manufactured by incrementally adding metal powder layer by layer, and, in the metal powder bonded body, a ratio of tensile strength TS2 after being exposed to hydrogen to tensile strength TS1 before being exposed to hydrogen satisfies Equation (1):

0.7<TS2/TS1<1.1. Equation (1):

In accordance with yet another embodiment, there is provided a metal powder bonded body having excellent hydrogen embrittlement resistance, wherein the metal powder bonded body is a metallic material having excellent hydrogen embrittlement resistance, the metallic material is a metal powder bonded body manufactured by incrementally adding metal powder layer by layer, and, in the metal powder bonded body, a ratio of elongation E2 after being exposed to hydrogen to elongation E1 before being exposed to hydrogen satisfies Equation (2):

0.7<E2/E1<1.1. Equation (2):

In accordance with still another embodiment, there is provide a metal powder bonded body having excellent hydrogen embrittlement resistance, wherein the metal powder bonded body is a metallic material having excellent hydrogen embrittlement resistance, the metallic material is a metal powder bonded body manufactured by incrementally adding metal powder layer by layer, and, in the metal powder bonded body, a ratio of reduction of area RA2 after being exposed to hydrogen to reduction of area RA1 before being exposed to hydrogen satisfies Equation (3):

0.7<RA2/RA1<1.1. Equation (3):

There is provided a metal powder bonded body having excellent hydrogen embrittlement resistance, wherein the metal powder bonded body is a metallic material having excellent hydrogen embrittlement resistance, the metallic material is a metal powder bonded body manufactured by incrementally adding metal powder layer by layer, and, in the metal powder bonded body, a difference between a fraction Mf of a martensite phase after completion of a tensile test in a state of being exposed to hydrogen and a fraction Mb of a martensite phase before being exposed to hydrogen satisfies Equation (4):

|Mf−Mb|≦10. Equation (4):

The metal powder may include at least one of an iron alloy (including pure iron), steel, Ni-based alloy powder (including pure nickel (Ni)), Zr-based alloy powder (including pure zirconium (Zr)), W-based alloy powder (including pure tungsten (W)), rare earth metal powder, and transition metal powder.

The metal powder bonded body may include one in which single metal powder or heterogeneous metal powder is bonded.

The metal powder bonded body may include one in which metal powder and ceramic powder are bonded.

The metal powder bonded body may include one in which at least one of metal oxide, metal nitride, and metal carbide is present in a dispersed form in a metal matrix.

According to embodiments of the present invention as described above, there is provided a metal powder bonded body, in which hydrogen embrittlement resistance is dramatically improved in comparison to a conventional metallic material. Of course, the scope of the present invention is not limited by these effects.

### BRIEF DESCRIPTION OF THE DRAWINGS

FIG. 1 is a graph illustrating tensile test results of experimental examples of the present disclosure in an atmospheric state and a hydrogen atmosphere;

FIG. 2 is a graph illustrating tensile test results of comparative examples in an atmospheric state and a hydrogen atmosphere;

FIGS. 3A and 3B illustrate results of scanning electron microscopic observation of fracture surfaces of the experimental examples after the tensile test;

FIGS. 4A and 4B illustrate results of scanning electron microscopic observation of fracture surfaces of the comparative examples after the tensile test;

FIGS. 5A and 5B illustrate tensile test results of comparative example 1 and comparative example 2, respectively, in which fracture occurred after the tensile test.

FIGS. 6A and 6B illustrate tensile test results of experimental example 1 and experimental example 2, respectively, in which fracture occurred after the tensile test.

FIGS. 7A and 7B conceptually illustrate the behavior of dislocations causing plastic deformation during the tensile tests of comparative example 1 and experimental example 1, respectively.

### DETAILED DESCRIPTION OF EMBODIMENTS

Hereinafter, preferred embodiments of the present disclosure will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

A metallic material having excellent hydrogen embrittlement resistance according to an embodiment of the present disclosure is a metal powder bonded body which is manufactured by incrementally adding metal powder layer by layer. The metal powder bonded body denotes one in which integrated structure, shape, and characteristics are provided by physically and chemically bonding the metal powder so that it may function as a single member.

The metal powder includes all forms in which pure metals or alloys are manufactured in the form of particles. The powder, for example, may be prepared by an atomizing process using gas injection or water injection, an electrolysis method, a chemical reaction method, or a mechanical grinding method. The metal powder is integrated by a subsequent additive manufacturing process to be converted into a metallic material having a desired shape. The metallic material integrated by the bonding of the metal powder as described above may be referred to as the metal powder bonded body.

The metal powder of the present disclosure may exemplarily include an iron alloy (including pure iron) or powder of steel. The powder of steel may include chromium (Cr), nickel (Ni), or manganese (Mn) as an alloying element. The steel may exemplarily include carbon steel, stainless steel, Cr—Mo steel, or nitrogen steel.

As another example, the metal powder may include Ni-based alloy powder (including pure Ni), Zr-based alloy powder (including pure zirconium (Zr)), or W-based alloy powder (including pure tungsten (W)). As another example, the metal powder may include rare earth metal powder or transition metal powder used in the manufacture of a sintered magnet.

The metal powder is converted into the metal powder bonded body through an additive manufacturing process. The additive manufacturing refers to a technique for manufacturing three-dimensional objects by continuously reconstructing digitized three-dimensional product designs into two-dimensional cross sections and incrementally adding a material layer by layer. This additive manufacturing is commonly referred to as “3D printing” in the industry and “additive manufacturing” means “3D printing” throughout the specification.

The metal powder bonded body according to the embodiment of the present invention may be manufactured by 3D printing using a metal power, wherein, for example, a powder layer of several tens of micrometers is laid on a powder bed having a predetermined area in a powder feeder, and is selectively irradiated with laser or electron beams according to designs, and then is melted and stacked layer by layer.

As another example, the metal powder bonded body may be manufactured by a method in which powders are supplied in real time in a protective gas atmosphere and melted and stacked immediately after supply using a high output laser.

A method of manufacturing the metal powder bonded body according to the embodiment of the present disclosure is not limited to the above-described method, but may additionally include any process as long as it is a process that may bond and integrate the metal powder together such as continuously reconstructing objects into two-dimensional cross sections and adding a material layer by layer.

A metal powder bonded body according to a modified embodiment of the present disclosure may include a bonded body, in which heterogeneous metal powder as well as single metal powder is mixed and bonded, or a bonded body in which metal powder and ceramic powder are mixed and bonded. Here, the metal powder bonded body can be manufactured by 3D printing using mixed powders prepared by mixing different metal powders or by mixing metal powders and ceramic powders, or can be manufactured by 3D printing with different powders supplied through different powder feed nozzles.

A metal powder bonded body according to another modified embodiment may include one in which a non-metallic material including ceramic, for example, an oxide, nitride, or carbide of metal, is present in a dispersed form in a metal matrix.

The metal powder bonded body according to the embodiment of the present disclosure exhibits excellent hydrogen embrittlement resistance which is not shown in a conventional casting material or a processed material prepared by plastic working of the casting material. For example, when compared with the conventional casting material or the processed material, the metal powder bonded body has better resistance to hydrogen embrittlement of the material even if it is exposed to the same hydrogen environment.

With respect to a conventional metallic material, even if it has sufficient ductility and tensile strength before being exposed to a hydrogen environment, brittle fracture typically occurs in a state in which hydrogen embrittlement occurs after being exposed to the hydrogen environment or in a case in which an external force is simultaneously applied when the material is exposed to the hydrogen environment. Since cracks propagate along a cleavage plane in the brittle fracture, a plurality of cleavage planes is observed in a cross section after the fracture, and low tensile strength is obtained because the fracture of the material occurs with almost no plastic deformation.

However, the metal powder bonded body according to the embodiment of the present disclosure has high resistance to hydrogen embrittlement even if it is exposed to the same hydrogen environment, and thus, the metal powder bonded body according to the embodiment of the present disclosure exhibits characteristics of ductile fracture which are similar to the fracture appearance before being exposed to hydrogen. In the ductile fracture, necking occurs due to considerable plastic deformation before the fracture, and one side of a fracture surface has a cup shape with local protrusions and the other side thereof has a cone shape or a dimple shape corresponding to the cup shape.

For example, the metal powder bonded body according to the embodiment of the present disclosure may exhibit characteristics of ductile fracture in an area of 80% or more of a total area of a fracture section when fractured in a hydrogen atmosphere.

In the characteristics of ductile fracture, a fracture mode including dimples without a cleavage plane may be shown in the area of 80% or more of the total fracture section during the observation of the fracture section.

As another example, in the metal powder bonded body according to the embodiment of the present disclosure, a ratio of tensile strength TS2 after being exposed to hydrogen to tensile strength TS1 before being exposed to hydrogen may satisfy Equation (1).

0.7<TS2/TS1<1.1 Equation (1):

Preferably, a minimum value of Equation (1) may be greater than 0.7, such as 0.8, and more preferably, may be 0.9.

As another example, in the metal powder bonded body according to the embodiment of the present disclosure, a ratio of elongation E2 after being exposed to hydrogen to elongation E1 before being exposed to hydrogen may satisfy Equation (2).

0.7<E2/E1<1.1 Equation (2):

Preferably, a minimum value of Equation (2) may be greater than 0.7, such as 0.75, and more preferably, may be 0.8.

As another example, in the metal powder bonded body according to the embodiment of the present disclosure, a ratio of reduction of area RA2 after being exposed to hydrogen to reduction of area RA1 before being exposed to hydrogen may satisfy Equation (3).

0.7<RA2/RA1<1.1 Equation (3):

Preferably, a minimum value of Equation (3) may be greater than 0.7, such as 0.75, and more preferably, may be 0.8.

In a case in which a hydrogen storage container, a pipe required to move hydrogen, and other parts exposed to a hydrogen environment are manufactured from the metal powder bonded body according to the embodiment of the present disclosure, a risk of sudden brittle fracture due to hydrogen embrittlement may be significantly reduced in comparison to the conventional case.

Hereinafter, preferred experimental examples will be described to allow for a clearer understanding of the present disclosure. However, the following experimental examples are merely provided to allow for a clearer understanding of the present disclosure, rather than to limit the scope thereof.

Experimental Examples and Comparative Examples

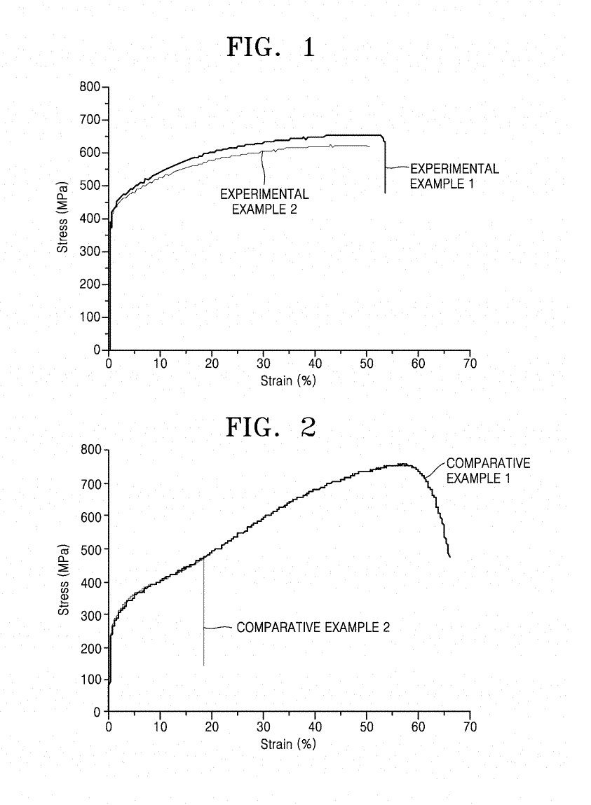

Metal powder bonded bodies of experimental examples were manufactured from 304L stainless steel powder by using a 3D printing method, a kind of pressure sintering method. In contrast, comparative examples were conventional rolled plates of commercial 304L stainless steel. The experimental examples and the comparative examples were subjected to tensile tests in an atmospheric state and an atmosphere having a hydrogen pressure of 10 MPa, respectively. FIGS. 1 and 2 are graphs illustrating tensile test results of the experimental examples and the comparative examples in an atmospheric state and a hydrogen atmosphere, respectively. Table 1 illustrates a summary of the tensile test results of the experimental examples and the comparative examples.

TABLE 1

| | | | Elastic | Tensile | | |
|---|---|---|---|---|---|---|
| | Manufacturing | | modulus | strength | Reduction of | Elongation |
| Specimen | process | Atmosphere | (GPa) | (MPa) | area (%) | (%) |
| Experimental | 3D printing | Air | 188 | 652 | 47.4 | 64.3 |
| Example 1 | | | | | | |
| Experimental | 3D printing | Hydrogen | 172 | 623 | 43.0 | 59.1 |
| Example 2 | | (10 MPa) | | | | |
| Comparative | Rolling | Air | 190 | 754 | 74.1 | 62.3 |
| Example 1 | | | | | | |
| Comparative | Rolling | Hydrogen | 182 | 468 | 17.1 | 19.2 |
| Example 2 | | (10 MPa) | | | | |

Referring to FIGS. 1 and 2 and Table 1, the conventional 304L stainless steel rolled plate, as the comparative example, had a tensile strength of 754 MPa and an elongation of 62.3% in an air atmosphere (Comparative Example 1). However, in a case in which the tensile test was performed in a hydrogen atmosphere having a hydrogen pressure of 10 MPa, tensile strength and elongation were respectively 468 MPA and 19.2%, which were only about 62% and about 30% of the experimental results obtained in the air atmosphere, respectively (Comparative Example 2).

In contrast, Experimental Example 1 had a tensile strength of 652 MPa and an elongation of 64.3% in an air atmosphere, and Experimental Example 2 tested in a hydrogen atmosphere having a hydrogen pressure of 110 MPa had a tensile strength of 623 MPa and an elongation of 59.1%, wherein the results of Experimental Example 2 showed a similarity of 90% or more to the results obtained in the air atmosphere.

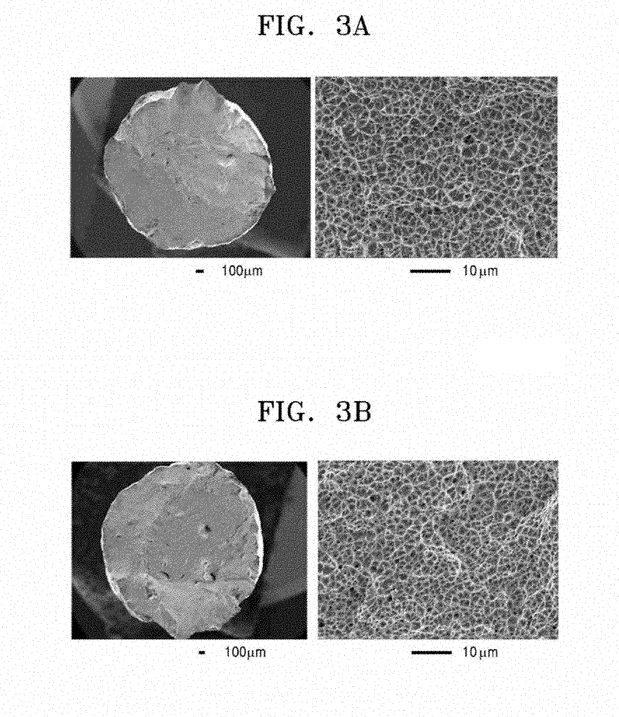

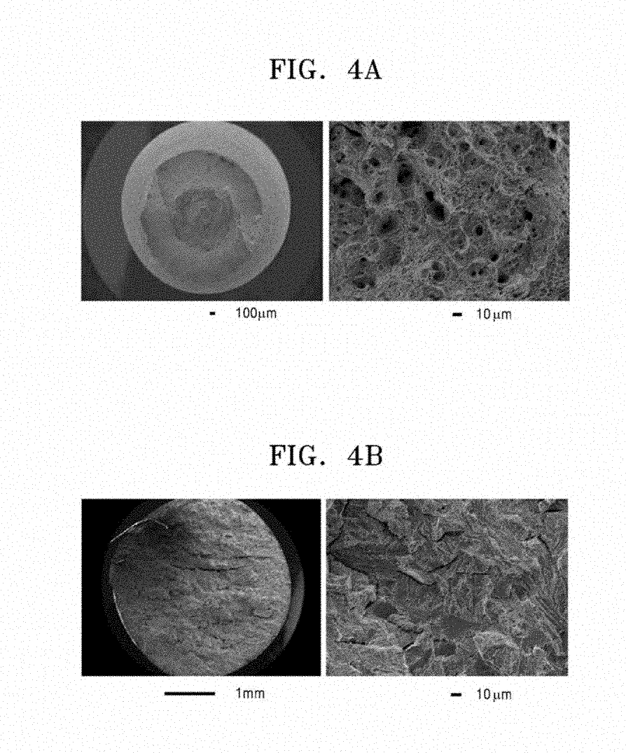

FIGS. 3A and 3B illustrate results of scanning electron microscopic observation of fracture surfaces of Experimental Examples 1 and 2 after the tensile test, and FIGS. 4A and 4B illustrate results of scanning electron microscopic observation of fracture surfaces of Comparative Examples 1 and 2 after the tensile test. In FIGS. 3A to 4B, low-magnification images are shown on the left, and high-magnification images are shown on the right.

Referring to FIG. 4, with respect to Comparative Example 1, the fracture surface of the tensile specimen fractured in the atmospheric state exhibited typical characteristics of ductile fracture in which a plurality of dimples was observed. However, referring to Comparative Example 2 of FIG. 4B, the fracture surface of the tensile specimen in the hydrogen atmosphere exhibited typical characteristics of brittle fracture in which a plurality of cleavage planes was observed. Referring to the reduction of area in Table 1, the comparative example had a reduction of area of 17.1% when the tensile test was performed in the hydrogen atmosphere, wherein it may be confirmed that brittle fracture occurred while necking due to plastic deformation hardly occurred when compared with a reduction of area of 74.1% which is the result of the tensile test in the air.

In contrast, referring to FIGS. 3A and 3B, with respect to the experimental examples, it may be confirmed that both of the tensile test specimens fractured in the atmospheric state and the hydrogen atmosphere had almost no fracture appearance along the cleavage plane as evidence of brittle fracture, but exhibited typical characteristics of ductile fracture in which a plurality of dimples was present. Referring to the reduction of area in Table 1, with respect to the experimental example, the reduction of area was 43.0% when the tensile test was performed in the hydrogen atmosphere, wherein it may be confirmed that inherent plastic deformation characteristics were not significantly changed by hydrogen, but most of the inherent plastic deformation characteristics were maintained when compared with a reduction of area of 47.4% which is the result of the tensile test in the air.

From the above results, it may be confirmed that, different from the comparative examples manufactured by rolling the conventional casting material, the experimental examples manufactured by incrementally adding the powder layer by layer, as a raw material, had significantly high resistance to hydrogen embrittlement.

It is considered that the reason for the excellent hydrogen embrittlement resistance of the experimental examples is related to strain-induced phase transformation occurred during the deformation. According to reports published so far, it is known that one of important factors influencing hydrogen embrittlement of steel is phase transformation from an austenite phase to a martensite phase. Since the martensite phase is very hard phase, the martensite transformation promotes hydrogen embrittlement to induce brittle fracture of the material.

In contrast, the metal powder bonded body according to the embodiment of the present disclosure had characteristics in which the transformation from austenite to martensite was suppressed even if it was deformed in a hydrogen environment. For example, during conventional tensile testing, a difference between a fraction Mf of a martensite phase after the completion of the tensile test (i.e., at the end of the fracture of tensile specimen) and a fraction Mb occupied by a martensite phase in a total structure before the tensile test may satisfy Equation (4) below. Herein, the fraction of the martensite phase, as a ratio of an area occupied by the martensite phase in an observed area of an analysis target or a faction, is expressed as a percentage (%).

|Mf−Mb|≦10 Equation (4):

Preferably, a value of |Mf−Mb| in Equation (4) may be 7 or less, for example, 5 or less.

For each of experimental examples 1 and 2 and comparative examples 1 and 2, the change of the phase distribution before and after the tensile test was observed by electron backscatter diffraction (EBSD). Before the tensile test, comparative examples 1 and 2 were mainly composed of an austenite phase and no martensite phase was observed. However, when they were subjected to severe plastic deformation through tensile test, it was confirmed that a large portion of the austenite phase was transformed into a martensite phase.

In comparative example 1 tested in the atmosphere, the phase fraction (area fraction) of the martensite phase after the tensile test was 90% or more. In comparative example 2, which has experienced a relatively less transformation due to brittleness, the phase fraction of the martensite phase was 70% or more. As a result, it was confirmed that the austenite phase before the tensile test had been transformed into the martensite phase during the tensile test.

On the other hand, experimental examples 1 and 2 were mainly composed of an austenite phase before the tensile test, and experienced almost no phase transformation into a martensite phase after the tensile test such that the phase fraction of the martensite phase was observed to be less than 1%.

That is, in the comparative examples, a large portion of the austenite phase is transformed into a martensite phase due to severe plastic deformation in the atmosphere or under hydrogen atmosphere. In the experimental examples, however, it was confirmed that most of the austenite phase remained stable without being transformed into a martensite phase in the atmosphere or under hydrogen atmosphere after the tensile test.

This property was evidence showing that the material according to the embodiment of the present disclosure was a material having resistance to hydrogen embrittlement, and, according to the phase stability, it was considered that deterioration of mechanical properties was prevented and the fracture surface also exhibited typical characteristics of ductile fracture which show resistance to hydrogen embrittlement.

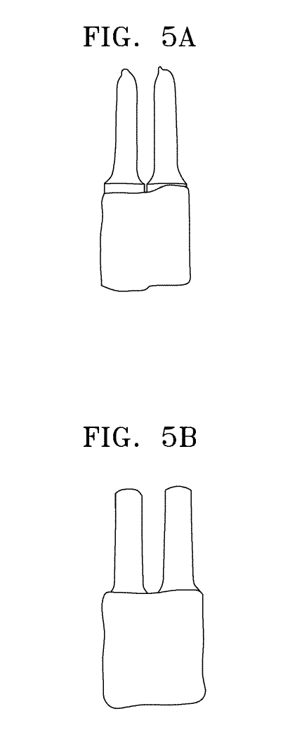

FIGS. 5A and 5B illustrate tensile test results of comparative example 1 and comparative example 2, respectively, in which fracture occurred after the tensile test.

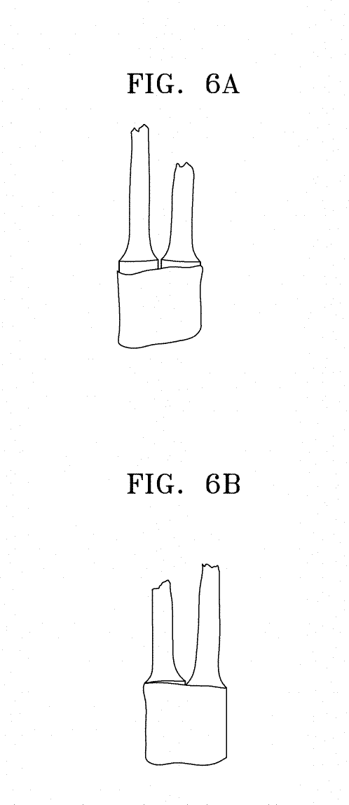

FIGS. 6A and 6B illustrate tensile test results of experimental example 1 and experimental example 2, respectively, in which fracture occurred after the tensile test.

Referring to FIG. 5A, it is confirmed that necking occurred near the center of the specimen in the tensile test and stress was concentrated on the necking area such that fracture occurred. On the other hand, referring to FIG. 5B, it is confirmed that the specimen immediately fractured while almost no necking occurred due to typical hydrogen embrittlement.

On the other hand, Referring to FIGS. 6A and 6B, the experimental examples do not show significant differences in the fracture behavior of the specimens in the atmosphere or under hydrogen atmosphere. Furthermore, although both of the specimens showed a little necking at the center, the necking was relatively less than that of comparative example 1 (see FIG. 5A). If less necking occurs near the center of the specimen, the stress concentration phenomenon is reduced or relaxed such the stress is not locally concentrated but distributed throughout the specimen and therefore the elongation characteristic of the specimen is improved.

In the experimental examples and comparative examples, it appears that the difference in the necking characteristics in the tensile test in the atmosphere is due to different dislocation behavior and macro-deformation behavior.

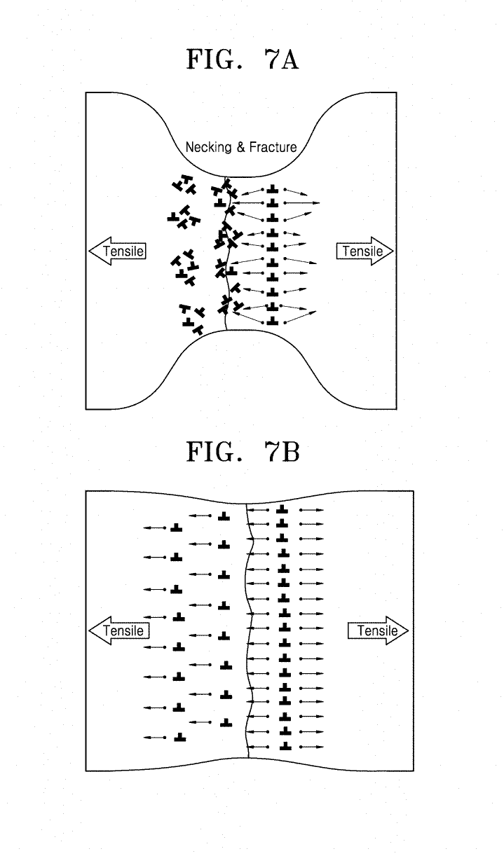

FIG. 7A conceptually illustrates such behavior of dislocations. Referring to FIG. 7A, tensile stress causes the generation and movement of dislocations, and moving dislocations are tangled or stacked with each other. As a result, stress concentration and strain localization occur in the region where the dislocations are tangled or when the dislocations are no longer able to move, and necking occurs.

In contrast, experimental example 1 shows a clear difference in nanoscale, microscale and macro-scale deformation behavior as compared with comparative example 1. Experimental example 1 shows somewhat unusual whole-body stretched deformation with slight necking unlike general plastic deformation during the tensile test. This means stress is not concentrated at any certain point, and energy dissipated throughout the specimen.

FIG. 7B conceptually illustrate the behavior of dislocations of experimental example 1. Referring to FIG. 7B, dislocations move short distances in approximately aligned parallel directions and therefore areas in which the dislocations are tangled or stacked are rarely produced. This dislocation behavior is particularly unique and depresses stress concentration and necking.

The unique behavior of dislocations of the metal powder bonded body according to the technical idea of the present invention can be another reason for the higher resistance to hydrogen embrittlement than that of a conventional metal material such as the comparative examples, for example, a metal material that is subject to plastic working after casting. That is, as shown in FIG. 7A, when the dislocations are tangled during plastic working and therefore the stress is concentrated, the hydrogen embrittlement can proceed rapidly. On the other hand, as shown in FIG. 7B, when the dislocations move short distances in approximately aligned parallel directions and therefore are hardly tangled, the hydrogen embrittlement proceeds relatively slowly. Accordingly, the resistance to hydrogen embrittlement increases.

Although the present disclosure has been described with reference to the embodiment illustrated in the accompanying drawings, it is merely illustrative, and those skilled in the art will understand that various modifications and equivalent other embodiments of the present disclosure are possible. Thus, the true technical protective scope of the present disclosure should be determined by the technical spirit of the appended claims.

What is claimed is:

1. A metal powder bonded body having excellent hydrogen embrittlement resistance,
wherein the metal powder bonded body is a metallic material having excellent hydrogen embrittlement resistance,
the metallic material is a metal powder bonded body manufactured by incrementally adding metal powder layer by layer, and
the metal powder bonded body has characteristics of ductile fracture in an area of 80% or more of a total area of a fracture section when fractured in a hydrogen atmosphere.

2. A metal powder bonded body having excellent hydrogen embrittlement resistance,
wherein the metal powder bonded body is a metallic material having excellent hydrogen embrittlement resistance,
the metallic material is a metal powder bonded body manufactured by incrementally adding metal powder layer by layer, and
in the metal powder bonded body, a ratio of tensile strength TS2 after being exposed to hydrogen to tensile strength TS1 before being exposed to hydrogen satisfies Equation (1):
0.7<TS2/TS1<1.1. Equation (1):

3. A metal powder bonded body having excellent hydrogen embrittlement resistance,
wherein the metal powder bonded body is a metallic material having excellent hydrogen embrittlement resistance,
the metallic material is a metal powder bonded body manufactured by incrementally adding metal powder layer by layer, and
in the metal powder bonded body, a ratio of elongation E2 after being exposed to hydrogen to elongation E1 before being exposed to hydrogen satisfies Equation (2):
0.7<E2/E1<1.1. Equation (2):

4. A metal powder bonded body having excellent hydrogen embrittlement resistance,
wherein the metal powder bonded body is a metallic material having excellent hydrogen embrittlement resistance,
the metallic material is a metal powder bonded body manufactured by incrementally adding metal powder layer by layer, and
in the metal powder bonded body, a ratio of reduction of area RA2 after being exposed to hydrogen to reduction of area RA1 before being exposed to hydrogen satisfies Equation (3):
0.7<RA2/RA1<1.1. Equation (3)

5. A metal powder bonded body having excellent hydrogen embrittlement resistance,
wherein the metal powder bonded body is a metallic material having excellent hydrogen embrittlement resistance,
the metallic material is a metal powder bonded body manufactured by incrementally adding metal powder layer by layer, and
in the metal powder bonded body, a difference between a fraction Mf of a martensite phase after completion of a tensile test in a state of being exposed to hydrogen and a fraction Mb of a martensite phase before being exposed to hydrogen satisfies Equation (4):

|Mf−Mb|≦10. Equation (4):

6. The metal powder bonded body having excellent hydrogen embrittlement resistance of claim 1, wherein, in the characteristics of ductile fracture in the area of 80% or more of the total area of the fracture section, a fracture mode including dimples without a cleavage plane is shown in the area of 80% or more of the total fracture section during observation of the fracture section.

7. The metal powder bonded body having excellent hydrogen embrittlement resistance of of claim 1, wherein the metal powder comprises at least one of an iron alloy (including pure iron), steel, Ni-based alloy powder (including pure nickel (Ni)), Zr-based alloy powder (including pure zirconium (Zr)), W-based alloy powder (including pure tungsten (W)), rare earth metal powder, and transition metal powder.

8. The metal powder bonded body having excellent hydrogen embrittlement resistance of claim 1, wherein the metal powder includes 304L stainless steel powder.

9. The metal powder bonded body having excellent hydrogen embrittlement resistance of claim 1, wherein the metal powder bonded body comprises one in which single metal powder or heterogeneous metal powder is bonded.

10. The metal powder bonded body having excellent hydrogen embrittlement resistance of claim 1, wherein the metal powder bonded body comprises one in which metal powder and ceramic powder are bonded.

11. The metal powder bonded body having excellent hydrogen embrittlement resistance of claim 1, wherein the metal powder bonded body comprises one in which at least one of metal oxide, metal nitride, and metal carbide is present in a dispersed form in a metal matrix.
